(19) United States
(12) Patent Application Publication
(10) Pub. No.: US 2009/0322286 A1
(43) Pub. Date: Dec. 31, 2009

(54) ENERGY SOURCE

(76) Inventor: Vijay Jagdish Chheda, Pune (IN)

Correspondence Address: LUCAS & MERCANTI, LLP, 475 PARK AVENUE SOUTH, 15TH FLOOR, NEW YORK, NY, 10016, US

(21) Appl. No.: 12/438,691

(22) PCT Filed: Jul. 25, 2007
(86) PCT No.: PCT/IN07/00318

§ 371 Date: Apr. 21, 2009

(30) Foreign Application Priority Data
Jul. 26, 2006 (IN) 1184/MUM/2006

(51) Int. Cl. H02J 7/00

(52) U.S. Cl. 320/137

(57) ABSTRACT

A magneto-charged power system for a vehicle, comprising a battery and a bank of ultracapacitors in parallel.

### FIELD OF THE INVENTION

This invention relates to an energy source.

In particular, this invention relates to an energy source for engines.

Still particularly, this invention relates to two wheeled vehicles having with a magneto.

### BACKGROUND OF THE INVENTION

Engines of different kinds and different capacity are used for driving a variety of machines, automobiles and the like. Internal combustion (IC) engine is one such type of engine which finds wide applicability in many industries. Internal combustion (IC) engines are often used to drive automobiles, gensets, earth moving machinery and the like.

Internal combustion engines are usually self starting, however IC engine having cubic capacity over a certain limit require an electric starter motor to start. Conventionally, engines are started using a battery. The power required to start an engine determines the size of the battery. There exists a direct relationship between the power required to start an engine and the size of the battery used to start the engine. Usually a larger battery is used for engines to compensate for cold weather starts, multiple and frequent starts and considering the life of the battery being used. In most cases, it is observed that life of the battery ranges from 2.5 to 3 years. Further, to ensure that the battery lasts the complete period, it has to be continuously serviced.

The service and maintenance of the battery is essential for the battery to serve its rated life of 2.5 to 3 years. It is often observed that the batteries do not last the rated life time because of poor maintenance. Further if batteries of a lower power are used to drive engines of higher capacity, it reduces the life of the battery as the battery is overloaded. In such cases, batteries of higher power capacity are required. However batteries of higher power capacity are large in size and costly.

Although this system is adapted for engines on two-wheeled vehicles, they may also cater to non-vehicular engines.

This invention seeks to overcome the limitations of the prior art.

### OBJECTIVES OF THE INVENTION

An object of this invention is to provide a power source which reduces deep-discharge during cranking.

Another object of this invention is to provide a power source which is maintenance free.

Yet another object of this invention is to provide a power source with reduced replacement costs.

Still another object of this invention is to provide a power source which relegates the need for servicing it.

An additional object of this invention is to provide a power source with a reduced charging time.

Yet an additional object of this invention is to provide a power source which requires a reduced charging power.

Still an additional object of this invention is to provide a power source which provides for a reduced pro-rata operational cost.

Still an additional object of this invention is to provide a power source with reduced lead pollution.

Another object of this invention is to provide a power source with reduced weight.

### SUMMARY OF THE INVENTION

In accordance with this invention there is provided an energy source for starting an engine with a higher capacity, said energy source comprising a conventional battery with an ultra capacitor connected in parallel to said battery.

An ultra capacitor has the capability to deliver high power in comparison to a conventional battery. But the energy storage capacity of the battery is higher than the ultra capacitor. Thus using the battery and ultra-capacitor in parallel it is possible to combine advantages of both the battery as well as the ultra capacitor. The higher power delivery requirement of the engine is met by the ultra capacitor while the higher energy requirement is met by the battery.

Typically, a magneto-charged power system comprises:
a) a battery;
b) a plurality of ultracapacitors forming an ultracapacitor bank whose effective voltage rating is greater than the voltage rating of said battery and is connected in parallel to said battery;
c) a first set of conductors for connecting the said system to a magneto, said magneto connected in series with said system for charging said system; and
d) a second set of conductors for connecting said system to a load for conducting power.

If the battery voltage rating is greater than ultracapacitor voltage rating, excess voltage across ultracapacitor will be more and may cause the ultracapacitor to be damaged.

Conventional batteries are lead acid batteries of 5, 9 and 12 Ampere-hour (A-h) rating depending on vehicle engine capacity. Normal loads like turn signals, horn and brake light are taken care of with this battery. The size of the battery is governed by starter motor requirement. Deep discharge at the time of cranking reduces the life of the battery drastically as compared to normal use. In accordance with an embodiment of this invention, downsizing of battery takes place from its original size typically to ⅓^{rd} or ½ of said original size. Typically, a 5A-h conventional battery can be replaced by a 1.3A-h battery in conjunction with a series of ultracapacitors. The ultracapacitor in this case, is rated, typically at 8.33F and 15V.

Similarly, a 9 A-h battery can be replaced typically by a 3.3 A-h battery with ultracapacitor rating, typically of 16.66 F and 15V.

In accordance with a preferred embodiments of this invention, said battery is a valve-regulated lead acid (VRLA) battery.

Typically, a plurality of ultracapacitors are joined together in series to form a capacitor bank with cumulative voltage rating which is higher than the voltage rating of said battery.

Typically, internal resistance of battery is greater than internal resistance of capacitor.

Typically, said magneto charges said battery and said ultracapacitor.

Typically, the system provides 60% -70% of power from said ultracapacitor and 30% -40%of power from said battery under laboratory conditions at factory settings.

Furthermore, the magneto-charged power system in accordance with this invention has reduced weight. Typically the weight reduces to half the conventional battery's weight. A conventional battery typically weighs 2 kg. The battery in accordance with this invention, typically weighs 1 kg.

In a preferred embodiment of this invention where a VRLA battery is used, the system is maintenance free as it does not require servicing or topping up with distilled water for regeneration purposes.

In IC engines of the type to which the invention relates to, a magneto is connected to the system which may be efficiently used to recharge the system. The magneto is coupled to a crankshaft of the engines. The magneto acts as a generator which converts mechanical energy to electrical energy to provide charging power to the battery as long as the engine operates irrespective of the whether the vehicle is moving or not. In turn, the power from the battery is consumed intermittently for indicator lights, brake lights, turn lights, horn and such other pieces of equipment. Headlight is generally separately connected to the magneto.

The charging current required to charge the system is reduced due to downsizing of battery. According to the prior art, typically 0.5 A of charging current was used. In accordance with this invention, the battery typically needs a mere 0.2 A of charging current.

Typically, said system includes a switch.

Typically, said switch is a solenoid switch.

According to a further embodiment of this invention, there is an economic advantage of said battery. Existing batteries are priced, typically in the range of Rs. 850/- to Rs. 1100/- with a life cycle of 2-3 years, provided it is serviced promptly at regular intervals. The battery in accordance with this invention, is competitively priced at Rs. 1150/-. The capacitors have a very long life, typically greater than 10 years and hence, only the battery needs to be replaced every 2-3 years at a price which is equivalent to 25% of current battery price, typically in the range of Rs. 200/- to Rs. 300/-. This reduces the per-day cost of starting an engine typically from Rs. 3/- and Rs. 4/- to less than Re. 1/-

According to another embodiment of this invention, the battery is replaced by a sealed VRLA battery. Due to downsizing of battery, the lead content in the battery is reduced, and the system's lead content is typically equivalent to ⅓^{rd} the lead content in conventional batteries.

### ADVANTAGES

Higher power delivery ensures faster starting of the engine, hence less energy is consumed per start, which in turn does not reduce battery life.

For driving an engine of a higher capacity, a small size conventional battery is sufficient.

The use of an ultra capacitor in parallel with the battery improves cold weather performance of the battery.

Since the size of the battery used is small, the overall weight reduces. Lower power battery is inexpensive as compared to a higher power battery, thus results in cutting of costs when the battery has to be replaced.

The life and performance of the parallel combination is better than the life and performance of the battery alone, as the ultra capacitor charges very fast as compared to the conventional battery.

### BRIEF DESCRIPTION OF THE ACCOMPANYING DRAWINGS

The invention will now be described in relation to the accompanying drawings in which:

FIG. 1 illustrates a magneto-charged power system in assembly with an engine and recharging assembly.

### DETAILED DESCRIPTION OF THE ACCOMPANYING DRAWINGS

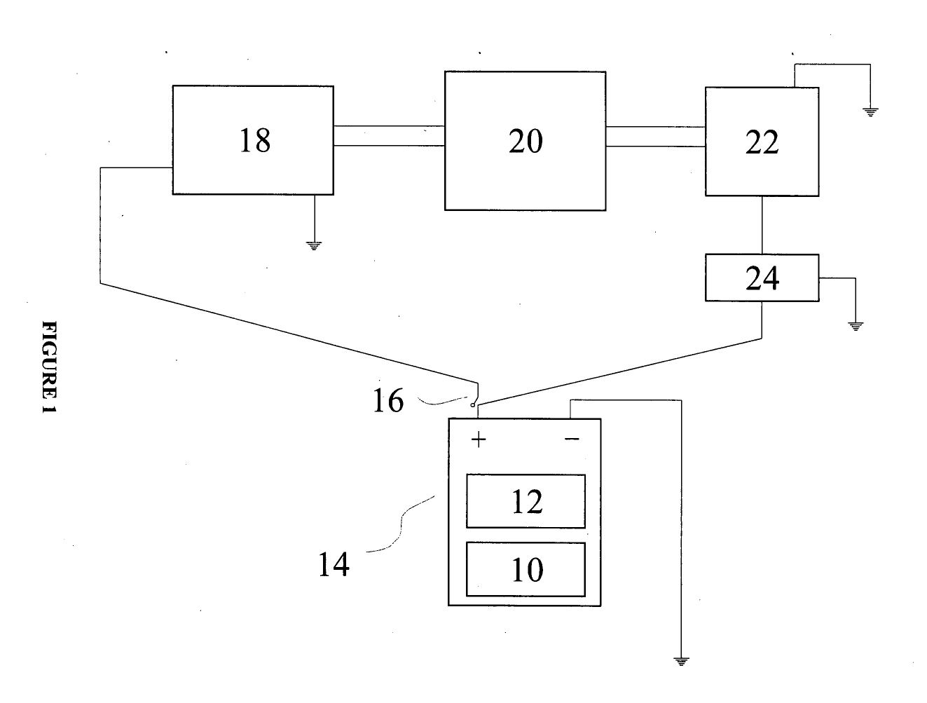

FIG. 1 of the accompanying drawing illustrates a magneto-charged power system in accordance with this invention in assembly with an engine and recharging assembly.

A magneto-charged power system comprises a battery (10) which is electrically connected in parallel to a plurality of ultracapacitors (12) forming an ultracapacitor bank provide the hybrid battery (14) in accordance with this invention. The positive terminal of the hybrid battery (14) is connected to a solenoid switch (16) which permits the flow of electricity to a starter motor (18). The starter motor (18) is electrically connected to an engine (20) in order to power it. The hybrid battery (14) in accordance with this invention eliminates the problem of deep discharge during cranking. A regenerative assembly is further established from the engine (20) to the hybrid battery (14). The engine (20) is electrically connected to a magneto (22) governed by a regulator-rectifier (24) in series. Further, the regulator-rectifier (24) output is given to the hybrid battery (14).

Invention is now illustrated with the help of a non-limiting example. A two-wheeled vehicle was fitted with a conventional battery and various operational parameters were measured, typically, the first peak current, the cranking current, the initial voltage, the cranking voltage, and the cranking RPM. The same two-wheeled vehicle was now fitted with a power source in accordance with this invention and the same parameters were recorded. The comparative and tabulated results of these trials are provided herein table 1. Similar tests were carried out on a variety of two_wheeled vehicles.

TABLE 1

| | | First peak current (A) | | | Cranking current (A) | | | | | |
|---|---|---|---|---|---|---|---|---|---|---|
| | | | Ultracap | | | Ultracap | | | | |
| | | Battery | unit | Total | Battery | unit | Total | Initial | Cranking | |
| | Power | current | current | current | current | current | current | Voltage | voltage | Cranking |
| Vehicle | Source | (A) | (A) | (A) | (A) | (A) | (A) | (V) | (V) | RPM |
| TVS - | 5 AH | 160 | — | 160 | 20 to 18 | — | 20-18 | 13.35 | 11.9-11.7 | 690 |
| Scooty | 1.2 AH + | 62 | 76 | 138 | 12 to 18 | 8 to 0 | 20-18 | 13.75 | 11.8-10.8 | 670-632 |
| PEP+ | 50 F | | | | | | | | | |
| | UC Unit | | | | | | | | | |
| Honda | 5 AH | 120 | — | 120 | 22 | — | 22 | 12.85 | 11.8 | 655-642 |
| Activa | 1.2 AH + | 42 | 66 | 108 | 14 to 20 | 8 to 2 | 22 | 13.45 | 11.4-9.8 | 580-517 |
| | 50 F | | | | | | | | | |
| | UC Unit | | | | | | | | | |
| TVS | 9 AH | 280 | — | 280 | 28 | — | 28 | 12.8 | 11.6 | 570-515 |
| Apache | 3.3 AH + | 130 | 100 | 230 | 20-28 | 8-0 | 28 | 13 | 11.5-10.8 | 558-530 |
| | 100 F | | | | | | | | | |
| | UC Unit | | | | | | | | | |

While considerable emphasis has been placed herein on the device and the interrelationships between the component parts of the preferred device, it will be appreciated that many devices can be made and that many changes can be made in the preferred device without departing from the principles of the invention. These and other changes in the preferred devices as well as other devices in accordance with this invention will be apparent to those skilled in the art from the disclosure herein, whereby it is to be distinctly understood that the foregoing descriptive matter is to be interpreted merely as illustrative of the invention and not as a limitation.

1. A magneto-charged power system comprising:
a) a battery;
b) a plurality of ultracapacitors forming an ultracapacitor bank whose effective voltage rating is greater than the voltage rating of said battery and is connected in parallel to said battery;
c) a first set of conductors for connecting the said system to a magneto, said magneto connected in series with said system for charging said system; and
d) a second set of conductors for connecting said system to a load for conducting power.

2. A magneto-charged power system as claimed in claim 1 wherein, said battery is a valve regulated lead acid (VRLA) battery.

3. A magneto-charged power system as claimed in claim I which includes a plurality of ultracapacitors joined together in series to form a capacitor bank with cumulative voltage rating which is higher than the voltage rating of said battery.

4. A magneto-charged power system as claimed in claim 1 wherein, internal resistance of battery is greater than internal resistance of capacitor.

5. A magneto-charged power system as claimed in claim 1 wherein, said magneto charges said battery.

6. A magneto-charged power system as claimed in claim 1 wherein, said magneto charges said ultracapacitor.

7. A magneto-charged power system as claimed in claim 1 wherein, said system includes a switch.

8. A magneto-charged power system as claimed in claim 1 wherein, said switch is a solenoid switch.
